(19) United States
(12) Patent Application Publication
(10) Pub. No.: US 2007/0027244 A1
(43) Pub. Date: Feb. 1, 2007

(54) Ester blends based on branched alcohols and/or branched acids and their use as polymer additives

(76) Inventors: Dirk Schar, Klaus-Groth-Strasse (DE); Michael Gode, Andornsteig (DE)

Correspondence Address: C. JAMES BUSHMAN, 5718 WESTHEIMER, SUITE 1800, HOUSTON, TX, 77057, US

(21) Appl. No.: 10/545,101

(22) PCT Filed: Feb. 9, 2004
(86) PCT No.: PCT/EP04/01147

§ 371 Date: Sep. 11, 2006

(30) Foreign Application Priority Data
Feb. 10, 2003 (DE) 103 05 562.2

(51) Int. Cl. C08K 5/10

(52) U.S. Cl. 524/306; 524/284; 524/296

(57) ABSTRACT

The present invention relates to ester blends, their use as polymer additives, and to polymer compositions containing said ester blends.

The present invention relates to ester blends and their use as polymer additives. Furthermore, this invention relates to polymer compositions containing said ester blends.

Commercially available fatty alcohols and -acids have very different structures, depending on the raw materials source or the manufacturing process. Linear, saturated fatty alcohols of the chain lengths C₈ to C₂₂ can be obtained from natural fats and oils by hydrolysis or methanolysis followed by hydrogenation of the resultant acids or methyl esters. Longer-chained, linear, saturated fatty alcohols (C₂₂ to C₄₀) are present in natural waxes, e.g. in beeswax or montan waxes. Linear, saturated fatty alcohols having chain lengths from C₆ to C₂₀ can be obtained petrochemically by the Ziegler process using aluminium, hydrogen, and ethylene. In addition, products with chain lengths in the range from C₂₀ to C₆₀ can be produced by ethylene polymerisation and conversion of the resultant α-olefins into alcohols and acids (Unilin alcohols and -acids).

Semilinear fatty alcohols, such as NEODOL™ alcohols, can be synthesised by ethylene oligomerisation and subsequent selective hydroformylation of the α-olefins thus obtained. Such alcohols (modified oxoalcohols, termed ‘MO’) comprise approx. 80% primary, linear and saturated alcohols. The remainder is predominantly comprised of alcohols which are alkyl-branched in the 2-position to the alcohol group.

Conventional oxoalcohols (termed ‘NO’) are generally based on kerosene. Here, first the stream of paraffins is isolated, which then are dehydrogenated to olefins and finally hydroformylated. The fatty alcohols thus obtained comprise approximately 50% primary, linear and saturated fatty alcohols.

Almost all the resultant branched alcohols are branched in the 2-position. Besides, it is known that this product stream can be split into linear and branched portions.

In addition to these fatty alcohols most of which are only monobranched, multibranched ones are also known. Such fatty alcohols are obtained by oligomerisation of propene and/or butenes plus hydroformylation. Typical chain lengths of such alcohols are in the range from C₆ to C₁₅, e.g. isononanol, isodecanol, and isotridecanol (modified fatty alcohols). The corresponding acids of the alcohols described hereinabove are known as well.

Lately, a new class of fatty alcohols has became accessible by hydroformylation of olefins obtained in the Fischer-Tropsch (FT) process using synthesis gas. In contrast to known fatty alcohols, the latter ones have special structural features. For example, there may be comprised approx. 50% branched molecules on the average, which is the same as for conventional oxoalcohols, but the majority of these molecules are not branched in the 2-position to the hydroxyl group, contrary to prior-art alcohols.

TABLE 1

| | Structures of Typical Oxoalcohols | | |
|---|---|---|---|
| | Conventional | Modified | Fischer-Tropsch |
| Linear alcohols | ˜45% | ˜80% | ˜50% |
| Branched alcohols | ˜55% | ˜20% | ˜50% |
| R—CH₂—CH₂—OH | ˜45% | ˜80% | ˜95% |
| R,R′CH—CH₂—OH | ˜55% | ˜20% | ˜5% |

It is the object of the present invention to provide novel ester blends which are particularly suitable as polymer additives. In addition, said blends ought to be very compatible with polymers and have excellent emission characteristics besides the advantage of a low melting temperature in comparison with esters based on linear alcohols.

The novel ester blends exhibiting surprising properties can be prepared from the alcohols and acids obtained in the Fischer-Tropsch process. Said ester blends are substantially composed of
esters with 1 to 4 carboxyl groups and 12 to 60 carbon atoms, which can be prepared by reaction of
   one or more carboxylic acid(s) which are optionally halogenated, wholly or in part, and/or one or more phosphoric acid(s) with
   one or more alcohol(s),
   wherein the carboxylic acids, the alcohols, or both (but at least one) are present as a mixture and the carboxylic acid mixture and/or the alcohol mixture comprise(s)
   alcohols according to the formula RCH₂OH and/or carboxylic acids according to the formula RCOOH, wherein
      (a) in more than 20 wt % to 80 wt % of the alcohols and/or acids used, preferably 40 to 70 wt %, the hydrocarbon radical R is linear and aliphatic, preferably saturated, and comprises 4 to 20 carbon atoms, preferably 7 to 12, and
      (b) in more than 10 wt % to 80 wt % of the alcohols and/or acids used, preferably 20 to 60 wt %, the hydrocarbon radical R is aliphatic, preferably saturated, and comprises 4 to 20 carbon atoms, preferably 7 to 12, of which up to 3, preferably 1 or 2, are tertiary ones and none of the tertiary carbon atoms is in the 2- or 3-position to the —OH group of the alcohol or acid, and wherein at least 80% of the tertiary carbon atoms, most preferably at least 95%, referring to the total of tertiary carbon atoms in the mixture, is not directly adjacent,
      and, optionally,
      (c) up to 10 wt % other alcohols or acids are comprised, preferably up to 5 wt %, which have 5 to 21 carbon atoms, preferably 8 to 13,
      wherein the alcohols, the acids, or both according to (a), (b), and (c) supplement one another to 100 wt %.

Preferred embodiments of the present invention are set out in the subordinate claims or are described in the following. It is preferable that the radicals R comprise on the average 11 to 12 carbon atoms, each referring to all the radicals R. The ester blends are blends of mixed esters. The percent by weight stated hereinabove refer to the composition of the ester blend.

The ester blends of the invention are prepared by reaction of mono-, di-, tri-, and tetraacids or phosphoric acid with monols, or of mono-, di-, tri-, and tetraols with monocarboxylic acids, wherein the carboxylic acid, the alcohol, or both are present as blends. If both are blends, these are the reaction products of monocarboxylic acids with monoalcohols.

By the term “polymer additives” as used herein is meant for example plasticisers, lubricants, release agents, viscosity reducers, antioxidants, and solvents. Their functions are contingent on both the ester structure and the type of polymer.

With respect to phthalate esters which, according to the instant invention, are particularly useful as PVC plasticisers, the compatibility limit averages out to about 13 carbon atoms in the alcohol residue. For example, a commonly known plasticiser is diisotridecylphthalate (DTDP), but there also exist plasticisers based on C₁₂-C₁₃ alcohol mixtures.

Owing to the limited compatibility of long-chain alcohol residues as such, it has been suggested in the art to use alcohol blends, wherein prior to the esterification, the long-chain C₁₂ and/or C₁₃ alcohol(s) is/are mixed with short-chain alcohols (ester mix). Notwithstanding the significantly superior compatibilities of prior-art ester/plasticiser blends, their heat age stability is unsatisfactory in comparison with the esters of the invention. It has surprisingly been found that the fatty alcohols obtained in the FT synthesis are particularly suitable for making polymer additive esters, especially for use as plasticisers, most preferably for PVC.

Preferably, the alcohols of the esters have a chain length from C₅ to C₁₅, preferably C₈ to C₁₃, most preferably C₁₂ to C₁₃. The acid can be an aliphatic, cyclic and/or aromatic acid. The aliphatic acid can be a branched or linear, saturated or unsaturated C₂- to C₂₂ monocarboxylic acid, such as formic acid, acetic acid, propanoic acid, butyric acid, isobutyric acid, pentanoic acid, caproic acid, heptanoic acid, caprylic acid, pelargonic acid, decanoic acid, lauric acid, myristic acid, palmitic acid, stearic acid, eicosanoic acid, tallow fatty acid, coconut fatty acid, palm fatty acid, ricinoleic acid, oleic acid, linoleic acid, linolenic acid, behenyl fatty acid, isostearic acid, isooctanoic acid, isononanoic acid, isodecanoic acid, 2-ethylhexanoic acid, 2-propylheptanoic acid, 2-butyloctanoic acid, 2-butyldecanoic acid, 2-hexyloctanoic acid, 2-hexyldecanoic acid, 2-hexyldodecanoic acid, 2-octyldecanoic acid, 2-octyldodecanoic acid, 2-decyltetradecanoic acid, 2-dodecylhexadecanoic acid, 2-tetradecyloctadecanoic acid, benzoic acid, cyclohexane carboxylic acid, glycolic acid, lactic acid, hydroxylbutyric acid, mandelic acid, glycerolic acid, acrylic acid, methacrylic acid, or di-, tri- or tetracarboxylic acids, such as oxalic acid, malonic acid, succinic acid, glutaric acid, adipic acid, pimelic acid, suberic acid, azelaic acid, sebacic acid, maleic acid, fumaric acid, phthalic acid, isophthalic acid, terephthalic acid, malic acid, tartaric acid, 1,2-cyclohexane dicarboxylic acid, trimellitic acid, citric acid, pyrromellitic acid, or tetrachlorophthalic acid.

In addition, the present invention relates to esters based on acids having a chain length from C₅ to C₁₅, preferably C₈ to C₁₃, most preferably C₁₂ to C₁₃, comprising for example aliphatic or cyclic or aromatic, branched or linear, saturated or unsaturated C₂- to C₂₂ monoalcohols, such as ethanol, propanol, isopropanol, butanol, isobutanol, pentanol, hexanol, heptanol, octanol, nonanol, decanol, dodecanol, tetradecanol, hexadecanol, octadecanol, eicosanol, tallow fatty alcohol, coconut fatty alcohol, palm fatty alcohol, castor-oil alcohol, oleyl alcohol, linolyl alcohol, linolenyl alcohol, behenyl alcohol, isostearyl alcohol, isooctanol, isononanol, isodecanol, 2-ethylhexane alcohol, 2-propylheptanol, 2-butyloctanol, 2-butyldecanol, 2-hexyloctanol, 2-hexyldecanol, 2-hexyldodecanol, 2-octyldecanol, 2-octyldodecanol, 2-decyltetradecanol, 2-dodecylhexadecanol, 2-tetradecyloctadecanol, benzyl alcohol, cyclohexanol, vinyl alcohol, lactic acid, hydroxylbutyric acid, mandelic acid, glycerolic acid, citric acid, phenols, or di-, tri- or polyols, such as ethyleneglycol, diethyleneglycol, triethyleneglycol, propyleneglycol, butyleneglycol, pentyleneglycol, hexyleneglycol, neopentylglycol, malic acid, tartaric acid, cyclohexane diols or glycerol, trimethylolpropane or alditols, diglycerides, triglycerides, polyglycerides, pentaerythritol or dipentaerythritol.

Said esters are useful as additives for various polymers, such polyvinyl chloride (PVC), polyvinylidene chloride (PVDC), polyacrylates (e.g. polymethylmethacrylate (PMMA), polyalkylmethacrylate (PAMA)), fluoride polymers (e.g. polyvinylidenefluoride (PVDF), polytetrafluoroethylene (PTFE)), polyvinylacetate (PVAc), polyvinyl alcohol (PVA), polyvinylacetal (e.g. polyvinylbutyral (PVB)), polystyrene polymers (e.g. polystyrene (PS), expandable polystyrene (EPS), acrylonitrile-styrene-acrylate (ASA), styreneacrylonitrile (SAN), acrylonitrile-butadiene-styrene (ABS), styrene-maleic anhydride copolymer (SMA), styrene-methacrylic acid copolymer), polyolefins (e.g. polyethylene (PE), polypropylene (PP), thermoplastic polyolefins (TPO), polyethylene vinyl acetate (EVA), polycarbonate (PC), polyethylene terephthalate (PETP), polybutylene terephthalate (PBTP), polyoxymethylene (POM), polyamide (PA), polyethyleneglycol (PEG), polyurethane (PU), thermoplastic polyurethane (TPO), biopolymers (e.g. polylactic acid (PLA), polyhydroxyl butyric acid (PHB), polyhydroxyl valeric acid (PHV)), polyester, starch, cellulose and cellulose derivatives (e.g. nitrocellulose (NC), ethyl cellulose (EC), cellulose acetate (CA), cellulose acetate/butyrate (CAB)), silicones as well as blends or copolymers of the abovementioned polymers or their monomer units.

Said esters are particularly suitable as plasticisers for PVC. The average molecular mass of PVC, which is defined as k value, is determined in accordance with DIN 53726. Typical k values are in the range from 60 to 100, i.e. the average molecular mass (average viscosity) is in the range from about 60,000 to >150,000 g/mol. Besides the molecular mass also the processing characteristics of PVC are affected by the manufacturing method. A distinction is made between suspension PVC (S-PVC), emulsion PVC (E-PVC), and bulk PVC, S-PVC and E-PVC being the most common.

A large number of additives can be added to the polymer plastic, primarily plasticisers and stabilisers, such as heat stabilisers, light stabilisers, antioxidants, and biostabilisers, but also fillers, lubricants, release agents, expanding agents, flame retardants, extenders, secondary plasticisers, pigments and dyes, antistatic agents, processing aids, impact resistance modifiers.

Plasticisers are usually esters, such as phthalates, trimellitates, citrates, adipates, sebacates, polyesters, sulfonates, phosphates, benzoates, glycerides, and rarely pyrromellitates and polyol esters. By heat stabilisers are generally meant metal soaps. Here, a distinction is made between single metal stabilisers, such as tin- and lead stabilisers, mixed metal stabilisers, such as cadmium-zinc stabilisers, barium-zinc stabilisers, calcium-zinc stabilisers, and metal-free, organic stabilisers, such as aminocrotonates, epoxidised soybean oil, phosphites, epoxy resins, α-diketones. By antioxidants are commonly meant sterically hindered phenols, thioesters, phosphites, and amines. The extenders or secondary plasticisers usually employed are for instance hydrocarbons, chloroparaffins, epoxidised soybean oil, and TXIB (2,2,4-tri-methylpentane-1,3-dioldiisobutyrate). Customary fillers are for example calcium carbonate, kaolin, carbon black, talcum, dolomite, silicates, and aluminates.

As to the lubricants, a distinction is made between internal rand external ones, the boundaries between the two groups being fluid. The lubricants usually employed are esters, such as isobutylstearate, distearylphthalate, glycerol monooleate (GMO), glycerol monostearate (GMS), di- and triglycerol fatty acid esters, stearyl stearate, coplex esters, fatty alcohols, fatty acids, soaps, amide waxes, oxidised and nonoxidised polyethylene waxes, and paraffins. Customary expanding agents are primarily chemical ones, such as azobisisobutyronitrile and toloylsulfohydrazide. Flame retardants are phosphates, antimony trioxide, aluminium hydroxide, magnesium hydroxide, chlorinated hydrocarbons, and borates. The commercially available stabilisers of today are chiefly multicomponent systems comprising besides heat stabilisers antioxidants, light stabilisers, lubricants, and liquefiers, including (secondary) plasticisers.

S-PVC is typically processed using the dry-blend method, whereas E-PVC is processed as a paste. Here, conventional mixers are employed in the first stage. The pastes then are processed for example by coating techniques or rotational casting. Dry blends are usually extruded, followed by calendering. Other conventional methods are injection moulding, blown-film process, slush moulding, and other techniques for processing thermoplastics.

The term ‘phr’ employed in the formulations means parts by weight per one hundred parts of polymer resin. The formulations comprise 1 to 150 phr plasticiser(s), 0.5 to 10 phr stabilisers, 0 to 50 phr fillers, and other additives as required.

The structures of FT fatty alcohols have proved to be particularly favourable for preparing PVC plasticisers, namely, with respect to polymer compatibility and mechanical properties of the resultant plastic sheets. Furthermore, the esters have more favourable melting temperatures in comparison with ester plasticisers based on linear alcohols so that they are easier to handle.

The statements made hereinabove will now be illustrated taking phthalates as an example. Esters based on various C_{12/13} alcohols were prepared for comparison and phthalates based on conventional oxoalcohol (NO type, LIAL™ 123 from SASOL), on modified oxoalcohol (MO type, NEODOL™ 23 from Shell), and on FT oxoalcohol (FT type, SAFOL™ 23 from SASOL, according to the invention) have been compared with each other. The state of the art is represented by high-performance phthalate plasticisers, such as di(decyl, lauryl, myristyl)phthalate (LINPLAST™ 1012 BP), di(octyl,decyl)phthalate (LINPLAST™ 810 P), and diisotridecylphthalate (LINPLAST™ 13 XP).

When comparing the esters, it becomes apparent that their melting points decrease gradually, namely, from MO phthalate via FT phthalate to NO phthalate. As to the melting point/pour point (clear point), the FT phthalate surprisingly behaves like a comparable phthalate of branched alcohols.

When comparing the gelling temperatures of various plasticisers, it becomes apparent that FT oxoalcohols are most suitable for preparing plasticisers. The gelling temperature, which is also a measure of the polymer compatibility of a plasticiser, is significantly lower than that of MO- and NO phthalates, the latter ones exhibiting the least favourable gelling behaviour.

When comparing the mechanical properties of various plasticiser-containing sheets, no remarkable difference has been found. However, it is evident that the compatibility of FT oxoalcohol-based plasticisers is superior, as can also be inferred from the gelling temperature. MO phthalates and NO phthalates perceptibly exude from a 33% standard plastic sheet, whereas FT C_{12/13} alcohol-based phthalates have found to be only slightly incompatible with such sheets.

However, when preparing a phthalate plasticiser based on a 70:30 blend of C_{12/13} alcohols and linear C₈₋₁₄ alcohols, e.g. LINCOL™ 812 H, the plasticiser containing FT oxoalcohol is completely compatible as compared to a product comprising a conventional oxoalcohol. Unlike prior-art products, no significant deterioration of the plasticiser volatility has been detected.

Hence, FT oxoalcohol-based plasticisers produce extremely low emissions (e.g. fogging, degradation on ageing) while their compatibility is still satisfactory. This is also demonstrated for example by cable formulations. In such filler-containing formulations no incompatibilities have been observed with C_{12/13} FT oxoalcohol-based phthalate.

Prior-art phthalates based on oxoalcohols made from tributene (diisotridecylphthalate) have excellent heat age stability. However, the heat age stability of C_{12/13} FT oxoalcohol-based phthalate is significantly superior to that of the abovementioned diisotridecylphthalate. Even the heat age stability of the phthalate plasticiser based on a 70:30 blend of C_{12/13} alcohols and linear C₈₋₁₄ alcohols, such as LINCOL™ 812 H, is inferior to that of said diisotridecylphthalate.

Yet another advantage of C_{12/13} FT oxoalcohol-based phthalates is their excellent low-temperature flexibilisation, which can be demonstrated for example by the Clash&Berg torsional stress test. This test reveals that, despite the slightly increased primary hardness of the sheets (cf. 100% modulus), C_{12/13} FT oxoalcohol-based phthalates present the same good low-temperature properties as the prior-art phthalates based on linear C₁₀₋₁₄ alcohol, such as LINPLAST™ 1012 BP from SASOL Germany GmbH. Therefore, C_{12/13} FT oxoalcohol-based phthalates are clearly superior to diisotridecylphthalates. The same applies to esters based on blends that are for instance comprised of linear alcohols and FT oxoalcohols.

Moreover, plastic sheets comprising FT oxoalcohol-based phthalates exhibit almost the same high thermal stabilities (congo red test) as sheets comprising phthalates which are completely based on linear alcohols, e.g. LINPLAS™ 1012 BP. These plasticisers thus have a distinct utilitarian advantage over conventional diisotridecylphthalates. Hence, FT oxoalcohol-based plasticisers are clearly superior to prior-art plasticisers.

Experiments

Feed

LINPLAS™ 13 XP (diisotridecylphthalate), LINPLAS™ 1012 BP (di(C₁₀-C₁₄ alkyl)phthalate), LIAL™ 123 (C₁₂-C₁₃ oxoalcohol), SAFOL™ 23 (C₁₂-C₁₃ FT oxoalcohol), LINCOL™ 810 (octanol/decanol blend), LINCOL™ 812 H (octanol/decanol/dodecanol/tetradecanol blend), from SASOL.

NEODOL™ 23 (modified C₁₂/C₁₃ oxoalcohol) from Shell.

NAFTOVIN™ T 80 (lead phthalate) from Chemson.

IRGASTAB™ BZ 561 (liquid barium/zinc stabiliser) from Cromton Vinyl Additives.

Ester Preparation

### EXAMPLE 1

### Preparation of SAFOL™ 23 Phthalate

4.4 moles of C_{12/13} FT alcohol (SAFOL™ 23) and 2.0 moles of phthalic anhydride, 0.15 wt % of tetraisopropyltitanate, and 150 ml of toluene were heated for 6 hours with reflux on the water separator. The temperature increased from 180° C. to 210° C. Towards the end of water separation, most of the entraining agent was distilled off. After cooling, the excess alcohol was separated on the molecular evaporator at 0.3 mbar and a jacket temperature of 145° C.

### Comparative Example 1

### Preparation of NEODOL™ 23 Phthalate

3.45 moles of C_{12/13}-modified oxoalcohol (NEODOL™ 23) and 1.57 moles of phthalic anhydride, 0.15 wt % of tetraisopropyltitanate, and 150 ml of xylene were heated for 5 hours with reflux on the water separator. The temperature increased from 160° C. to 180° C. Towards the end of water separation, most of the entraining agent was distilled off. After cooling, the excess alcohol was separated on the molecular evaporator at 0.13 mbar and a jacket temperature of 135° C.

### Comparative Example 2

### Preparation of LIAL™ 123 Phthalate

8.8 moles of C_{12/13} oxoalcohol (LIAL™ 123) and 4.0 moles of phthalic anhydride, 0.15 wt % of tetraisopropyltitanate, and 150 ml of cyclohexane were heated for 5½ hours with reflux on the water separator. The temperature increased from 160° C. to 190° C. Towards the end of water separation, most of the entraining agent was distilled off. After cooling, the excess alcohol was separated on the molecular evaporator at 0.06 mbar and a jacket temperature of 140° C.

### Example 2

### Preparation of SAFOL™ 23/LINCOL™ 812 H Phthalate

9.9 moles of a 70:30 blend of C_{12/13} FT alcohol (SAFOL™ 23) and linear C₈-C₁₄ alcohol (LINCOL™ 812 H), and 4.5 moles of phthalic anhydride, 0.15 wt % of tetraisopropyltitanate, and 150 ml of cyclohexane were heated for 2½ hours with reflux on the water separator. The temperature increased from 160° C. to 190° C. Towards the end of water separation, most of the entraining agent was distilled off. After cooling, the excess alcohol was separated on the molecular evaporator at 0.3 mbar and a jacket temperature of 115° C.

### Comparative Example 3

### Preparation of LIAL™ 123/LINCOL™ 812 H Phthalate

8.8 moles of a 70:30 blend of C_{12/13} oxoalcohol (LIAL™ 123) and linear C₈-C₁₄ alcohol (LINCOL™ 812 H), and 4.0 moles of phthalic anhydride, 0.15 wt % of tetraisopropyltitanate, and 150 ml of cyclohexane were heated for 5½ hours with reflux on the water separator. The temperature increased from 160° C. to 220° C. Towards the end of water separation, most of the entraining agent was distilled off. After cooling, the excess alcohol was separated on the molecular evaporator at 0.04 mbar and a jacket temperature of 140° C.

### Example 3

### Preparation of SAFOL™ 23/LINCOL™ 810 Phthalate

8.8 moles of a 50:50 blend of C_{12/13} FT alcohol (SAFOL™ 23) and linear C₈-C₁₀ alcohol (LINCOL™ 810), and 4.0 moles of phthalic anhydride, 0.15 wt % of tetraisopropyltitanate, and 150 ml of xylene were heated for 7 hours with reflux on the water separator. The temperature increased from 170° C. to 190° C. Towards the end of water separation, most of the entraining agent was distilled off. After cooling, the excess alcohol was separated on the molecular evaporator at 0.3 mbar and a jacket temperature of 125° C.

### Example 4

### Synthesis of SAFOL 23 acid

1950 g (10 mol) of SAFOL 23 alcohol was heated with 730 g (13 mol) of potassium hydroxide to 335° C. The hydrogen evolution was finished after 4 h. The resulting potassium soap was cooled to ambient temperature and was neutralised by the addition of an excess of sulphuric acid. After phase separation the organic layer was washed several times with water until the water phase reacted neutral.

### Example 5

### Preparation of pentaerytritol tetrakis(SAFOL 23 acid) ester

1500 (7.2 mol) of reaction product of example 1 (SAFOL 23 acid), 220 g (1.6 mol) of pentaerytritol, 200 ml of xylene and 2.6 g (0.15 weight %) tetraisopropyl titanate were heated in a flask to 180° C. At this temperature the separation of reaction water started. The heat was continuously increased up to 240° C. The teaction was stopped after 9 h. The hydroxyl value was determined by GC analysis and was calculated to 4.3 mg KOH/g. The excess of acid and the residual solvend were distilled off via a short pass distillation at 140° C. and 0.05 mbar. Pentaerytritol tetrakis(SAFOL 23 acid) ester was isolated as the distillation residue with an acid value of 0.15 mg KOH/g and a colour of 55 Hazen.

### Example 6

### Use of pentaerytritol tetrakis(SAFOL 23 acid) ester as PVC-lubricant

PVC test sheets were prepared based on the following formulation:

| | | |
|---|---|---|
| 100 | phr | PVC (K 70) |
| 50 | phr | plasticizer LINPLAST 610 P |
| | | (di(hexyl, octyl, decyl)phthalate) |
| 1.5 | phr | liquid Ba/Zn stabiliser (IRGASTAB BZ 561) |
| 0.3 | phr | lubricant (ester of example 2) |

The ingredients were mixed together and charged into a twin screw Brabender plasticorder and kneaded at 170° C. for 10 min. The troque curve gave a strong indication that the pentaerytritol tetrakis(SAFOL 23 acid) ester acts as an internal PVC-lubricant. The pregelated PVC compound (called doll) was easily removed from the screws. No discoloration was observed. Thereafter the compound was calandered on a two-roll calander for approx. 3 min. to a PVC foil of 0.5 mm thickness. Again no discoloration and no high volatility or fuming was observed.

Methods

The DIN and ISO standards and in-house test methods employed for testing the esters and plastic sheets under examination have been compiled in Table 4.

TABLE 2
33% PVC Flexible Sheet Formulation
(Formulation 1)

| | | |
|---|---|---|
| 100 | phr | S-PVC K70 |
| 50 | phr | plasticiser |
| 2.5 | phr | liquid Ba/Zn stabiliser (IRGASTAB ™ BZ 561) |
| 0.3 | phr | stearic acid |

TABLE 3
Cable Sheet Formulation
(Formulation 2)

| | | |
|---|---|---|
| 100 | phr | S-PVC K70 |
| 39 | phr | plasticiser |
| 20 | phr | chalk |
| 8.3 | phr | basic lead phthalate (Pb stabiliser, NAFTOVIN ™ T 80) |
| 0.8 | phr | calcium stearate |

TABLE 4
Methods of Test

| Characteristics | Dimension | | Methods |
|---|---|---|---|
| Density | [g/mol] | | DIN 51 757 |
| Kin. viscosity at | [cSt] | | DIN 51 562 |
| 40° C. and 100° C. | | | |
| Pour point | [° C.] | | DIN ISO 3016/ |
| | | | ASTM D 97 |
| Flash point | [° C.] | | DIN ISO 2592 |
| Smoke point | [° C.] | | A.O.C.S. Cc 9a-48 |
| Gravimetric fogging | [μg] | 62-EE-3* | DIN 75201 B |
| Reflectometric fogging | [%] | 62-EE-3* | DIN 75201 A |
| Solution temperature | [° C.] | 62-EE-1* | |
| Volume resistance | [Ω cm/10¹²] | | DIN 53 482 |
| 100% modulus | [N/mm²] | 62-EF-1* | DIN 53 455 |
| Elongation at break | [%] | 62-EF-1* | DIN 53 455 |
| Ultimate strength | [N/mm²] | 62-EF-1* | DIN 53 455 |
| Low-temperature | [° C.] | 62-EF-5* | DIN 53 457 |
| flexibility (according | | | |
| to Clash & Berg) | | | |
| Aging stability | [%] | 62-EF-3* | DIN 53 391 |
| Thermal stability | [min] | | DIN VDE 0472, |
| (Congo Red Test) | | | part 614 |
| Cable sheet properties | | | DIN VDE 0207, |
| | | | part 4Y-I-7 |

*in-house test method

Preparation of Plastic Sheets

(in-house method 62-HF-1, by analogy with DIN 7749, sheet 2)

The constituents listed hereinabove in the formulations 1 or 2 were placed into a porcelain jar and mixed with one another until a dry powder was obtained (dry blend). The powder was placed into a kneader (Brabender Plasti Corder) and kneaded for 10 minutes at 170° C. and 30 r.p.m. The compound thus prepared was aerated on the rolls for about 3 minutes at 170° C. and then taken off. The resultant sheets then were pressed in three steps using a hydraulic moulding press (Polystat 200S), namely for 1 minute at 170° C. /70 bar, for 3 minutes at 170° C. /200 bar, and at 200 bar with cooling from 170° C. to 100° C. The 33% PVC flexible sheets were thus pressed to 0.5 mm thickness, whereas the cable sheets had a thickness of 2 mm.

Melting Point Determination

(in-house method 61-EE-9)

About 50 ml of the compound under examination are placed into a pour-point beaker. A pour-point thermometer is stuck about 3 cm deep into the sample. The beaker then is placed into the cooling bath of a cryomat. The temperature of the coolant is gradually lowered until the sample turns solid. The cooling-bath temperature then is further reduced by at least 4° C., followed by slowly increasing the temperature by about 2° C. every 4 hours. The melting range is defined as the temperature range between melting start and complete melting.

Solution Temperature Determination

(in-house method 61-EE-9)

In a 50-ml beaker 2.5 mg of S-PVC K70 were suspended-in 47.5 mg of plasticiser. The temperature was slowly increased (approx. 1° C. /min). The solution temperature is defined as the temperature at which the S-PVC dissolves in the plasticiser and an Arial 12-type letter is clearly visible through the solution.

TABLE 5
Ester and Sheet Characteristics (33% Plasticiser)

| | | Example | | | | |
|---|---|---|---|---|---|---|
| | | | | | | Comparative |
| | | | | | Example 5 | Example 6 |
| | | | | | SAFOL ™ 23/ | LIAL ™ 123/ |
| | | Comparative | Comparative | | LINCOL ™ | LINCOL ™ |
| | | Example 4 | Example 5 | Example 4 | 812 H | 812 H |
| | | LIAL ™ 123 | NEODOL ™ | SAFOL ™ 23 | Phthalate | Phthalate |
| | | Phthalate | 23 Phthalate | Phthalate | (70:30) | (70:30) |
| Ester Characteristics | | | | | | |
| Density | [g/ml] | 0.943 | 0.942 | 0.951 | 0.954 | 0.949 |
| Dynamic viscosity at 20° C. | [mPa · s] | 92.3 | 82.0 | 77.7 | 78.9 | 75.8 |
| Solution temperature | [° C.] | 161 | 154 | 150 | 144 | 149 |
| Pour point | [° C.] | −15 | 2 | −12 | −18 | −21 |
| Gravimetric fogging | [μg] | 71 | <50 | 88 | 56 | 116 |
| Reflectometric fogging | [%] | >96 | >96 | >96 | >96 | >96 |
| Sheet Characteristics | | | | | | |
| 100% modulus | [N/mm²] | 12.6 | 12.3 | 12.6 | 12.2 | 12.5 |
| Ultimate strength | [N/mm²] | 21.4 | 21.0 | 21.6 | 21.3 | 21.8 |
| Elongation at break | [%] | 287 | 300 | 300 | 299 | 289 |
| Low-temperature flexibility: | [° C.] | −35 | −36 | −34 | −34 | −37 |
| 334.5 N/mm² | | | | | | |
| Clash & Berg 669 N/mm² | [° C.] | −49 | −48 | −49 | −48 | −51 |
| Loss in weight after 7 days/90° C. | [%] | 0.8^{[1]} | 0.8^{[1]} | 0.5^{[2]} | 0.6 | 0.6^{[2]} |
| Sheet Characteristics after | | | | | | |
| Aging (7 days/90° C.) | | | | | | |
| 100% modulus | [N/mm²] | 13.0 | 12.8 | 13.3 | 12.7 | 13.4 |
| Ultimate strength | [N/mm²] | 20.0 | 20.4 | 21.7 | 20.5 | 21.8 |
| Elongation at break | [%] | 268 | 288 | 292 | 282 | 279 |
| Low-temperature flexibility: | [° C.] | −36 | −36 | −35 | −35 | −35 |
| 334.5 N/mm² | | | | | | |
| Clash & Berg 669 N/mm² | [° C.] | −50 | −47 | −48 | −48 | −48 |

Example

| | | Example 6 | | | |
|---|---|---|---|---|---|
| | | SAFOL ™ 23/ | | | |
| | | LINCOL ™ | Comparative | Comparative | Comparative |
| | | 810 H | Example 7 | Example 8 | Example 9 |
| | | Phthalate | LINPLAST ™ | LINPLAST ™ | LINPLAST ™ |
| | | (50:50) | 810 P | 1012 BP | 13 XP |
| Ester Characteristics | | | | | |
| Density | [g/ml] | 0.959 | 0.968 | 0.951 | 0.951 |
| Dynamic viscosity at 20° C. | [mPa · s] | 64.4 | 47.0 | 54.8 | 267.6 |
| Solution temperature | [° C.] | 137 | 127 | 139 | 155 |
| Pour point | [° C.] | −25 | −25 | −3 | −45 |
| Gravimetric fogging | [μg] | 230 | 840 | 140 | nd |
| Reflectometric fogging | [%] | 92 | nd | 95 | nd |
| Sheet Characteristics | | | | | |
| 100% modulus | [N/mm²] | 10.3 | 9.8 | 10.1 | 13.5 |
| Ultimate strength | [N/mm²] | 20.9 | 20.8 | 21.4 | 21.7 |
| Elongation at break | [%] | 317 | 308 | 315 | 368 |
| Low-temperature flexibility: | [° C.] | −37 | −36 | −39 | −26 |
| 334.5 N/mm² | | | | | |
| Clash & Berg 669 N/mm² | [° C.] | −50 | −49 | −52 | −41 |
| Loss in weight after 7 days/90° C. | [%] | 0.9 | 1.2 | 0.8 | 0.6^{[1]} |
| Sheet Characteristics after | | | | | |
| Aging (7 days/90° C.) | | | | | |
| 100% modulus | [N/mm²] | 10.5 | 10.5 | 10.3 | 14.6 |
| Ultimate strength | [N/mm²] | 21.0 | 20.5 | 21.6 | 22.2 |
| Elongation at break | [%] | 314 | 299 | 299 | 267 |
| Low-temperature flexibility: | [° C.] | −37 | −35 | −38 | −26 |
| 334.5 N/mm² | | | | | |
| Clash & Berg 669 N/mm² | [° C.] | −50 | −47 | −50 | −42 |

nd = not determined;
^{[1]}= remarkable exudation of plasticiser (plasticiser incompatibility);
^{[2]}= moderate exudation of plasticiser (plasticiser incompatibility)

TABLE 6
Ester and Sheet Characteristics (Cable Sheets)

| | | Example | | | |
|---|---|---|---|---|---|
| | | | | Example 8 | Comp. Ex. 11 |
| | | | | SAFOL ™ 23/ | LIAL ™ 123/ |
| | | Comp. Ex. 10 | Example 7 | LINCOL ™ 812 H | LINCOL ™ 812 H |
| | | LIAL ™ 123 | SAFOL ™ 23 | Phthalate | Phthalate |
| | | Phthalate | Phthalate | (70:30) | (70:30) |
| Ester Characteristics | | | | | |
| Density | [g/ml] | 0.943 | 0.951 | 0.954 | 0.949 |
| Dynamic viscosity at 20° C. | [mPa · s] | 92.3 | 77.7 | 78.9 | 75.8 |
| Solution temperature | [° C.] | 161 | 150 | 144 | 149 |
| Pour point | [° C.] | −15 | −12 | −18 | −21 |
| Volume resistivity at 20° C. | [Ω · cm/10¹²] | 4.9 | 5.4 | 5.5 | 5.9 |
| Sheet Characteristics | | | | | |
| 100% modulus | [N/mm²] | 15.8 | 16.4 | 16.0 | 15.4 |
| Ultimate strength | [N/mm²] | 19.6 | 22.1 | 21.7 | 21.0 |
| Elongation at break | [%] | 251 | 319 | 316 | 319 |
| Low-temperature flexibility: | [° C.] | −20 | −18 | −17 | −19 |
| 334.5 N/mm² | | | | | |
| Clash & Berg 669 N/mm² | [° C.] | −38 | −35 | −34 | −35 |
| Thermal stability [Congo Red] | [min] | 283 | 275 | 277 | 282 |
| Volume resistivity at 80° C. | [Ω · cm/10¹²] | 0.13 | 0.13 | 0.24 | 0.27 |
| Loss in weight after 7 days/120° C. | [%] | 0.5 | 0.4 | 0.5 | 0.7 |
| Loss in weight after 7 days/100° C. | [%] | 0.2 | 0.2 | 0.2 | 0.2 |
| Loss in weight after 7 days/100° C. | [mg/cm²] | 0.3 | 0.3 | 0.3 | 0.3 |
| Sheet Characteristics after | | | | | |
| Aging (7 days/120° C.) | | | | | |
| 100% modulus | [N/mm²] | 16.6 | 16.3 | 16.4 | 16.4 |
| Ultimate strength | [N/mm²] | 19.2 | 20.4 | 20.9 | 20.6 |
| Elongation at break | [%] | 219 | 294 | 293 | 294 |
| Change in ultimate strength | [%] | −2 | −8 | −3 | −2 |
| Change in elongation at break | [%] | −13 | −8 | −7 | −8 |
| Low-temperature flexibility^{[1]}: | [° C.] | −18 | −17 | −18 | −18 |
| 334.5 N/mm² | | | | | |
| Clash & Berg 669 N/mm² | [° C.] | −35 | −33 | −33 | −34 |

Example

| | | Comp. Ex. 12 | Comp. Ex. 13 | |
|---|---|---|---|---|
| | | LINPLAST ™ | LINPLAST ™ | |
| | | 1012 BP | 13 XP | Y-I-7 |
| Ester Characteristics | | | | |
| Density | [g/ml] | 0.951 | 0.951 | |
| Dynamic viscosity at 20° C. | [mPa · s] | 54.8 | 267.6 | |
| Solution temperature | [° C.] | 139 | 155 | |
| Pour point | [° C.] | −3 | −45 | |
| Volume resistivity at 20° C. | [Ω · cm/10¹²] | 0.4 | 10.0 | |
| Sheet Characteristics | | | | |
| 100% modulus | [N/mm²] | 15.2 | 16.8 | — |
| Ultimate strength | [N/mm²] | 20.6 | 21.2 | >12.5 |
| Elongation at break | [%] | 310 | 268 | >125 |
| Low-temperature flexibility: | [° C.] | −19 | −12 | — |
| 334.5 N/mm² | | | | |
| Clash & Berg 669 N/mm² | [° C.] | −35 | −27 | — |
| Thermal stability [Congo Red] | [min] | 293 | 220 | >120 |
| Volume resistivity at 80° C. | [Ω · cm/10¹²] | 0.25 | 1.42 | >0.01 |
| Loss in weight after 7 days/120° C. | [%] | 0.8 | 0.7 | — |
| Loss in weight after 7 days/100° C. | [%] | 0.3 | 0.2 | — |
| Loss in weight after 7 days/100° C. | [mg/cm²] | 0.3 | 0.3 | <2 |
| Sheet Characteristics after | | | | |
| Aging (7 days/120° C.) | | | | |
| 100% modulus | [N/mm²] | 15.8 | 17.4 | — |
| Ultimate strength | [N/mm²] | 21.1 | 20.5 | — |
| Elongation at break | [%] | 293 | 255 | — |
| Change in ultimate strength | [%] | −2 | −3 | <25 |
| Change in elongation at break | [%] | −5 | −5 | <25 |
| Low-temperature flexibility^{[1]}: | [° C.] | −18 | −12 | — |
| 334.5 N/mm² | | | | |
| Clash & Berg 669 N/mm² | [° C.] | −34 | −29 | — |

^{[1]}= after aging for 7 days at 100° C.

1. An ester blend comprising
esters comprising 1 to 4 carboxyl groups and 12 to 60 carbon atoms, obtained by reacting
one or more carboxylic acid(s) having from 1 to 4 carboxyl groups which are optionally at least partly halogenated, and/or one or more phosphoric acid(s) with
one or more alcohol(s),
wherein the carboxylic acid(s), the alcohol(s), or both are present as a mixture and the carboxylic acid mixture and/or the alcohol mixture comprise(s)
alcohols according to the formula RCH₂OH and/or carboxylic acids according to the formula RCOOH, wherein
(a) in more than 20 wt % to 80 wt % of the alcohols and/or acids used the hydrocarbon radical R comprises 4 to 20 carbon atoms and is linear and aliphatic, and
(b) in more than 10 wt % to 80 wt % of the alcohols and/or acids used the hydrocarbon radical R is aliphatic and comprises 4 to 20 carbon atoms, of which up to 3 are tertiary ones, and none of the tertiary carbon atoms is in the 2- or 3-position to the —OH group of the alcohol or acid and, optionally, furthermore comprises
(c) up to 10 wt % other alcohols or acids having 5 to 21 carbon atoms,
wherein the alcohols, the acids, or both according to (a), (b), and (c) supplement one another to 100 wt %.

2. The ester blends of claim 1, wherein more than 70%, preferably more than 80% of the alkyl branches of the blend are methyl- and/or ethyl groups, preferably methyl groups.

3. An ester blend according to any one of the preceding claims, wherein more than 80%, preferably more than 95% of the radicals R of the blend have —CH₂—CH₂—groups which are linked to the —CH₂—OH or —COOH group.

4. An ester blend according to any one of claims 1 or 2, wherein each radical R comprises on the average 0.1 to 2 tertiary carbon atom(s), preferably 0.2 to 0.7.

5. An ester blend according to any one of claims 1 or 4, wherein the alcohol is one alcohol or a plurality of alcohols selected from the group consisting of ethyleneglycol, diethyleneglycol, triethyleneglycol, propyleneglycol, butyleneglycol, pentyleneglycol, hexyleneglycol, neopentylglycol, malic acid, tartaric acid, cyclohexane diols, glycerol, trimethylolpropane, alditols, diglycerides, triglycerides, polyglycerides, pentaerythritol, dipentaerythritol, C₆ to C₂₂ mono- or diols and mixtures thereof.

6. An ester blend according to any one of claims 1 or 2, wherein the mono-, di-, tri-, and/or tetracarboxylic acid is one carboxylic acid or a plurality of carboxylic acids selected from the group consisting of oxalic acid, malonic acid, succinic acid, glutaric acid, adipic acid, pimelic acid, suberic acid, azelaic acid, sebacic acid, maleic acid, fumaric acid, malic acid, tartaric acid, cyclohexane dicarboxylic acid, trimellitic acid, citric acid, pyrromellitic acid, a C₆- to C₂₂ mono- or dicarboxylic acid and mixtures thereof.

7. An ester blend according to any one of claims 1 or 2, wherein the mono-, di-, tri-, and/or tetracarboxylic acid is phthalic acid, isophthalic acid, and/or terephthalic acid or the tetrachloro-substituted derivative thereof.

8. A polymer blend comprising the esters according to any one of claims 1 or 2 and a polymer having a molecular weight of greater than 500 g/mol.

9. A polymer blend comprising 1 to 150 phr of the ester as claimed in any one of claims 1 or 2, preferably 20 to 100 phr, most preferably 30 to 60 phr.

10. A polymer blend as claimed in claim 8, wherein the polymer is PVC or the plastic material comprises as polymer PVC, preferably with a k value of 60 to 100 in accordance with DIN 53 726.

11. (canceled)

12. A polymer blend as claimed in claim 9, wherein the polymer is PVC or the plastic material comprises a polymer PVC, preferably with an h value of 60 to 100 in accordance with DIN 53 726.
